(19) United States
(12) Patent Application Publication
(10) Pub. No.: US 2023/0097046 A1
(43) Pub. Date: Mar. 30, 2023

(54) GAMING DEVICE WITH UPGRADEABLE FEATURE GAMES

(71) Applicant: Aristocrat Technologies Australia Pty Limited, North Ryde (AU)

(72) Inventors: Upinder Dhaliwal, Schofields (AU); Paul Connelly, Springwood (AU); Gaurav Goel, Uttar Pradesh (IN); Dean Agan, Glenmore Park (AU); Nitin Gupta, Parramatta (AU); Neil Street, Wyoming (AU); William Holland, Macquarie Park (AU); Stephen Jones-McQueen, North Ryde (AU); Leon Roberts, Caringbah South (AU); Nicholas O'Sullivan, Beacon Hill (AU); Samuel Walker, Marsfield (AU); Claudia Rae, Waitara (AU); Hanson Santoso, Box Hill (AU); Dinh Tran, Wetherill Park (AU)

(21) Appl. No.: 17/716,804

(22) Filed: Apr. 8, 2022

(30) Foreign Application Priority Data
Sep. 29, 2021 (AU) 2021240220

(51) Int. Cl. G07F 17/32

(52) U.S. Cl. CPC G07F 17/3262; G07F 17/3213

(57) ABSTRACT

A gaming device comprises a display, a random number generator, a processor, and a memory storing instructions. When the instructions are executed by the processor, they cause the processor to conduct a base game from which feature games and at least one composite feature game can be triggered, where the composite feature game comprises game play characteristics from a first feature game and a second feature game of the feature games, and the composite feature game comprises a combination of the different game play characteristics. The composite feature game is initiated in response to a composite feature trigger condition being met. The game instances are presented with one or more feature game icon, which are modified in presentation during the game instances in accordance with an associated game play characteristic for a particular instance.

### FIELD

The present application relates to a gaming device, a method of operating a gaming device and a system with upgradeable feature games.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

There is disclosed a gaming device, a method of operating a gaming device and a system where feature games can be upgraded. In some embodiments, a gaming device can conduct a base game from which a set of feature games can be triggered. In addition, at least one composite game can be triggered. The composite game includes a combination of game play characteristics for two or more of the set of feature games. In response to a feature trigger condition, the compose feature game is initiated, including a set of gaming instances having the combination of game play characteristics. The gaming instances of the composite feature game are presented in a display along with one or more feature game icons, corresponding to the feature games from which characteristics were combined for the composite feature game. The presentation of the feature game icons are modified during gameplay based on the associated game play characteristics for a particular instance. By doing so, the display overcomes the challenge of fitting contextual information into the display during gameplay. Further, the composite game solves the challenge of providing additional feature game options without becomes overly complex from numerous sets of feature game characteristics.

In some embodiments, the feature trigger condition for the composite game may be triggered from the base game, and/or may be triggered from a feature game or composite feature game. The feature trigger condition may include a symbol indicative of a particular combination of feature games, or may include a selected combination of symbols corresponding to the feature games from which the composite feature game is generated.

In some embodiments, the composite feature game can be upgraded based on an upgrade condition being satisfied. The upgrade condition may include, for example, an increased bet during game play. The upgraded composite feature game can include additional game play characteristics from one or more additional feature games.

In one example, a number of different feature games can be triggered from a base game which have different game play characteristics. After the feature starts, a game play characteristic from one of the other feature games can be added when an upgrade condition is met after which an upgraded feature is conducted that has game play characteristic of two or more of the different feature games.

An example embodiment describes a gaming device comprising a display, a random number generator, a processor, and a memory storing instructions. When the instructions are executed by the processor, they cause the processor to conduct a base game from which a plurality of feature games can be triggered, each of the plurality of feature games comprising different game play characteristics, wherein the base game comprises a spinning reel game in which the processor selects symbols from reel strips using the random number generator, initiate a feature game in response to a feature trigger condition being met in relation to the base game, the feature game comprising a plurality of game instances having at least a first game play characteristic, upon an upgrade condition corresponding to another feature game having a second game play characteristic being met during one of the plurality of game instances, set each remaining game instance of the plurality of game instances and at least one additional game instance to be conducted as a first composite feature game comprising the at least a first game play characteristic and the second game play characteristic, and conduct each remaining first game instance and the at least one additional game instance.

Another example embodiment describes a method of operating a gaming device comprising a display, a random number generator. The method comprises conducting a base game from which a plurality of feature games can be triggered, each of the plurality of feature games comprising different game play characteristics, wherein the base game comprises a spinning reel game in which the processor selects symbols from reel strips using the random number generator, initiating a feature game in response to a feature trigger condition being met in relation to the base game, the feature game comprising a plurality of game instances having at least a first game play characteristic, upon an upgrade condition corresponding to another feature game having a second game play characteristic being met during one of the plurality of game instances, setting each remaining game instance of the plurality of game instances and at least one additional game instance to be conducted as a first composite feature game comprising the at least a first game play characteristic and the second game play characteristic, and conducting each remaining first game instance and the at least one additional game instance.

Another example embodiment describes a system comprising:
at least one display;
a random number generator;
one or more processors; and
memory storing instructions which, when executed by the one or more processors, cause the one or more processors to:
conduct a base game from which a plurality of feature games can be triggered, each of the plurality of feature games comprising different game play characteristics, wherein the base game comprises a spinning reel game in which the processor selects symbols from reel strips using the random number generator;
initiate a feature game in response to a feature trigger condition being met in relation to the base game, the feature game comprising a plurality of game instances having at least a first game play characteristic;
upon an upgrade condition corresponding to another feature game having a second game play characteristic being met during one of the plurality of game instances, set each remaining game instance of the plurality of game instances and at least one additional game instance to be conducted as a first composite feature game comprising the at least a first game play characteristic and the second game play characteristic; and conduct each remaining first game instance and the at least one additional game instance.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIG. 6 is a flow chart showing detail of FIG. 5.

FIG. 7 is an example screen display.

FIG. 8 is an example of a virtual button deck.

FIGS. 9 to 21 are exemplary screen displays.

### DETAILED DESCRIPTION

The following description relates to systems, devices, and techniques for providing upgradeable feature games in a gaming device setting. Generally, a game mechanic is provided in which a feature games of different types are playable from a base game. In addition, one or more composite feature games are provided which merge the playable features or game play characteristics of two or more of the feature games. As such, the composite games improve the functionality of an EGM by providing additional feature games based on current feature games for example by combining game mechanics from multiple feature games, thereby expanding playable options without having to generate entirely new feature games.

Typically, feature games are initiated when one or more symbols associated with the feature game are selected. In some embodiments described herein, a new symbol is provided which represents a combination of two or more feature games, thereby adding a technical improvement to the gameplay by providing an additional triggering event for a feature game having particular characteristics. Moreover, a composite game may be triggered based on a combination of feature game-specific symbols being selected, or the new symbol being selected, thereby enhancing the gameplay by providing multiple paths to reach a particular composite feature game.

In addition, in some embodiments, a user interface for the game is provided for a game which may include a feature icon representative of one or more feature games. In some embodiments, the presentation of the feature game icon may change during gameplay based on a gaming characteristic of a current feature game or composite game. As such, the improved user interface enhances the presentation of the game by providing contextual information about the game during gameplay.

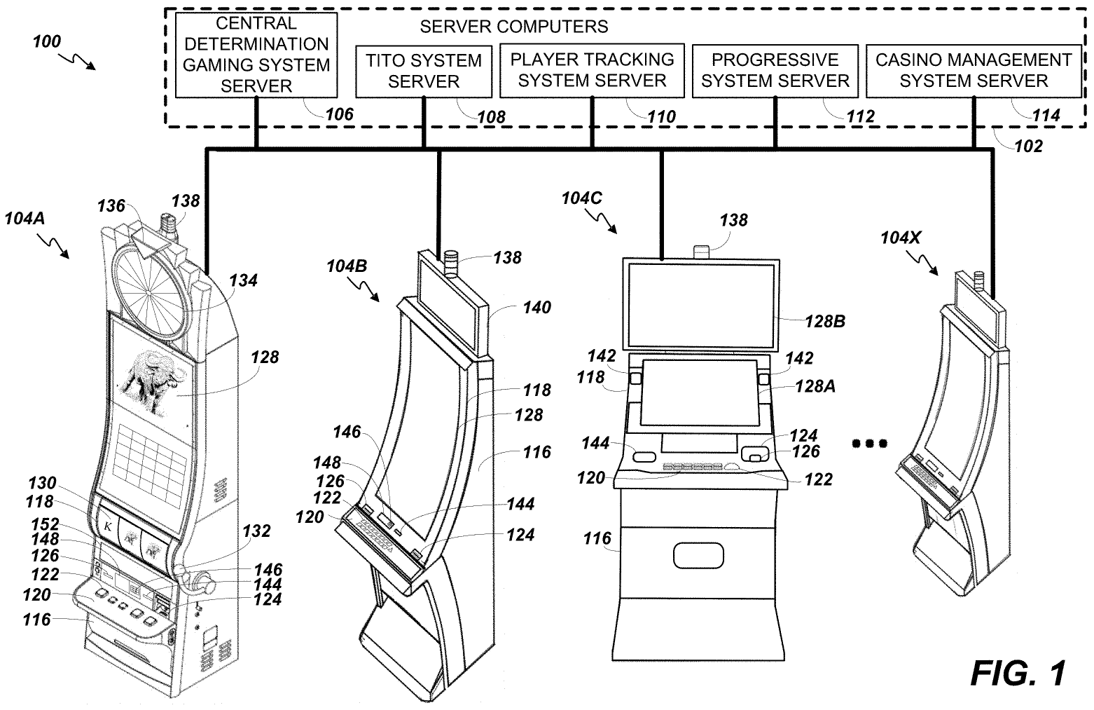

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 1046 or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

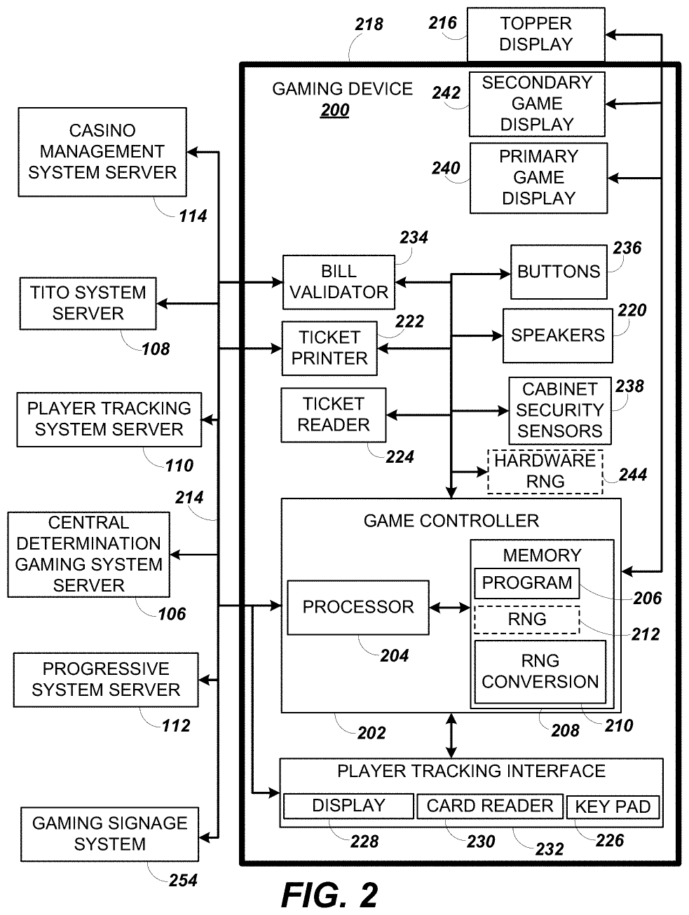

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 1046 does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-1040 and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the players playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

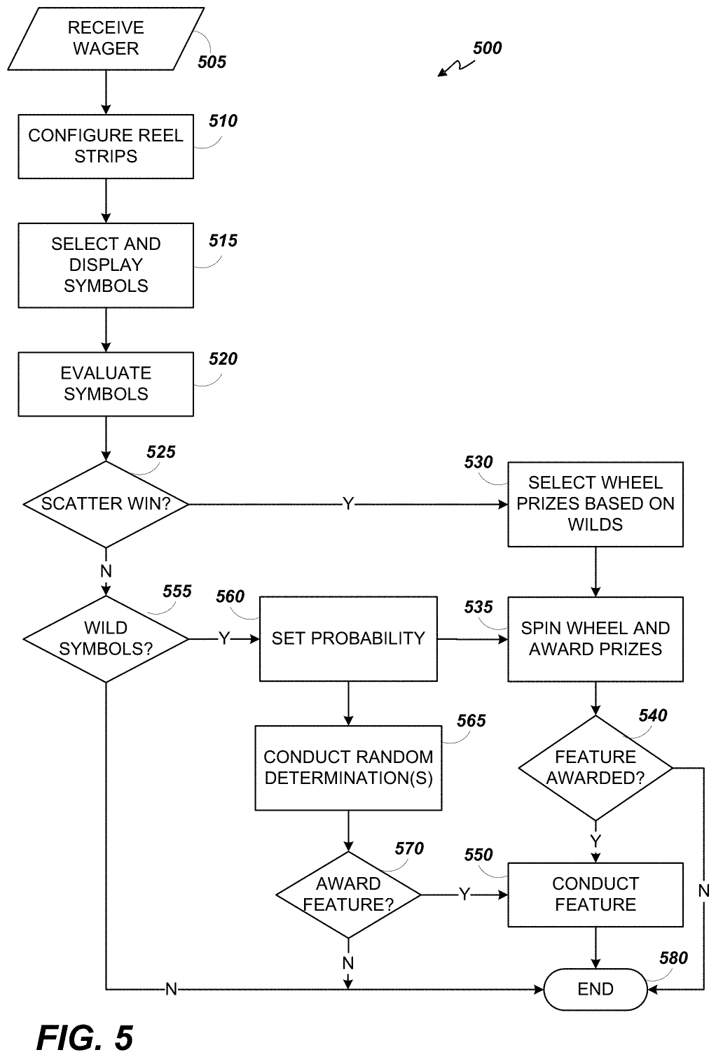

FIG. 5 is a flow chart of an example embodiment of a method 500 of operating a gaming device. At step 505, the processor 204 initiates a first game instance (e.g. a base game) in response to receiving a wager.

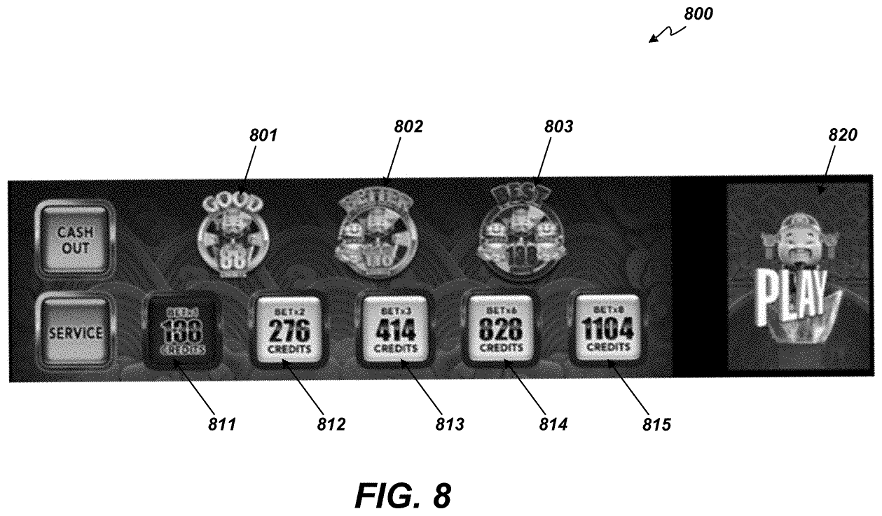

In this example, virtual button deck 800 as shown in FIG. 8 is presented on the touch screen display 240 and a player makes a wager selection using buttons 801-803, and 811-815 and then pressing “Play” button.

In this example, there are three bet option buttons: 1. 88 credits (801); 2. 118 credits (802); and 3. 138 credits (803). In this example, the bet options affect the aspects of game play that the gaming device activates as explained in more detail below. Each bet button is associated with a bet option icon, which includes a visual representation of feature games available when that bet option is selected. As such, the first button (801) is an icon that features a character (“CHOY”). The second button (802) is an icon that features the character and a PURPLE PIG, indicating that at the second level of wager, a feature game associated with the PURPLE PIG is available. Similarly, the third button (803) is an icon that features the character, the PURPLE PIG, and the GREEN PIG, indicating that at the third level of wager, a feature game associated with the PURPLE PIG is available, as well as a feature game associated with the GREEN PIG. Beneath the bet option buttons are five bet multiplier options 811-815 which also indicate the total bet for the selected option.

An example of bet multipliers and total wager amounts is set out in Table 1 below.

TABLE 1

| Bet Option (credits) | Bet Multipliers | Total Bet (credits) |
|---|---|---|
| 88 | 1, 2, 3, 6, 8, 10 | 88, 176, 264, 528, 880 |
| 118 | 1, 2, 3, 6, 8 | 118, 236, 354, 708, 944 |
| 138 | 1, 2, 3, 6, 8 | 138, 276, 414, 828, 964 |

FIG. 8 shows an example, where the player has selected the 138 credit bet option 803 with the ×1 bet multiplier 811. As such, the ×2 bet multiplier 812, the ×3 bet multiplier 813, the ×4 bet multiplier 814, and the ×5 bet multiplier 815 remain unselected.

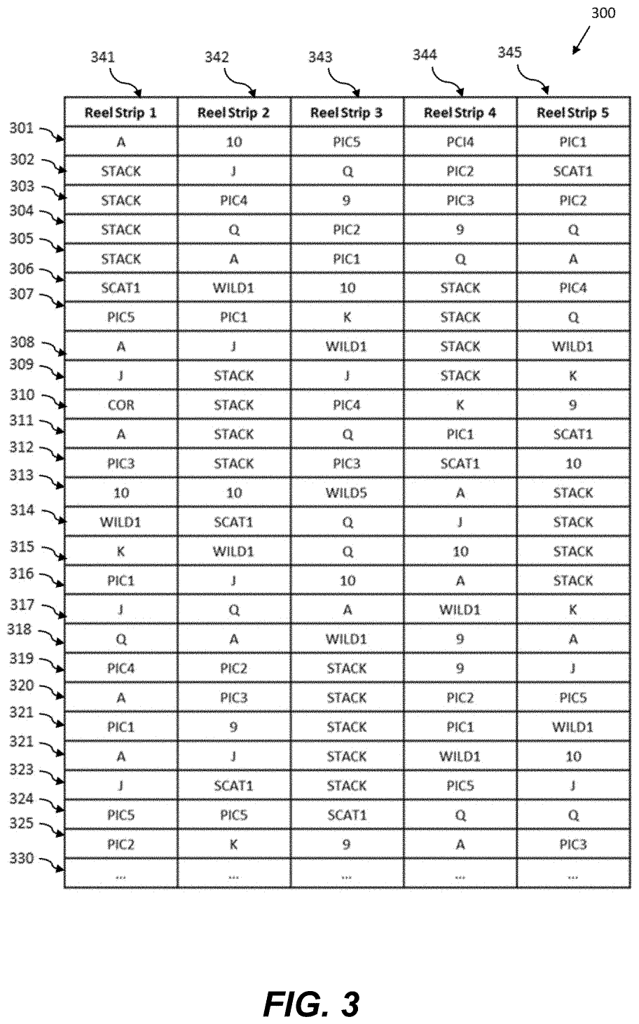

At step 510, the processor 204 configures the reel strips for a current game instance in dependence on the received wager. In this respect, FIG. 3 illustrates an example of a set 300 of five reel strips 341, 342, 343, 344, 345. In the example, for illustrative purposes, twenty-five reel strip positions 301-325 are shown for each reel strip 341-345. Each reel strip position of each reel has a symbol. For example, a “Wild1” symbol occupies the twenty-first reel strip position 321 of the fourth reel 344. The symbols shown on the reel strip are generally indicative of symbols that may be employed in the embodiments, however, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, the reel strips associated with different columns may be of different lengths to one another.

The reel strips 341-345 have STACK symbols, for example at the sixth to ninth reel strip positions 306-309 of the fourth reel strip. In the configuration step 510, the processor 204 uses random number generator 212 to determine whether STACK symbols will be the PIC1, PIC2, PIC3, PIC4 or PIC5 symbol.

Also at step 510, as part of the process of configuring the reels, processor 204 determines which wild symbols will be on the reel strips in the game instance. As explained in further detail below, as well as substituting for other symbols in evaluations of winning combinations from a pay table, the wild symbols can also result in the award of standalone or composite features. In this example, the set of wild symbols the reels can be configured with is dependent on the selected bet option. In this example, WILD1 is the default WILD symbol such that when the 88 credits bet option 801 is selected, WILD1 will remain as WILD1.

When playing 118 credits or above, each occurrence of WILD1 is independently evaluated by processor 204 using a weight table stored in memory 208 and values returned from RNG 212 to determine the symbol WILD1 may transform into. When the 118 credits bet option is active, the result of this process conducted by processor 204 is that WILD1 can change to WILD2 (or stay as WILD 1). When the 138 credits bet option is active, WILD1 can change to WILD2, WILD3, and WILD4 (or stay as WILD 1).

As explained in further detail below, when processor 204 selects symbol, selection of WILD1 may result in the processor 204 awarding Feature A during the 118 credit and 138 credit bet options only. When selected by processor 204, WILD1 substitutes for all symbols except WILD2, WILD3, and WILD4. Feature A also corresponds to Feature A icon 741 as shown in FIG. e7. In an example, the game mechanic of the feature game associated with Feature A is that all instances of stacked symbols on reels 2,3, and 4 become WILD5 during the Feature A feature game. That is, the processor 204 configures the reel strips in this way in each free game.

WILD2 occurs during the 118 credit and 138 credit bet options only. WILD2 takes the form of a PURPLE PIG symbol and corresponds to a PURPLE PIG feature icon 742 displayed above the reel window. WILD2 may result in the processor 204 awarding Feature B. When selected by processor 204, WILD2 substitutes for all symbols except WILD1, WILD3, and WILD4. In an example, the game mechanic of the Feature B feature game is that when the WILD2 symbol is selected for one of the symbol positions during a feature game instance, one or more wild reels are awarded by the processor 204 where every symbol is WILD5. The array of symbol positions will also grow by one or more rows as set out in Table 2 below.

TABLE 2

| WILDs selected | Possible Reel Height |
|---|---|
| 1 | 5 × 5 |
| 2 | 6 × 5 |
| 3 | 7 × 5 |

WILD3 occurs during the 138 credit bet option only. WILD2 takes the form of a GREEN PIG and corresponds to a GREEN PIG feature icon 742. displayed above the reel window. WILD3 may result in the processor 204 awarding Feature C. When selected by processor 204, WILD3 substitutes for all symbols except WILD1, WILD2, and WILD4. Feature C corresponds to third feature icon 742. The game mechanic of the feature game associated with Feature C is that the processor 204 determines a multiplier to apply for each free game by selecting form a set of possible multipliers using a weighted table. Processor 204 controls display 240 to display the multiplier prior to spinning the reels to a stop. If the selected symbols include one or more winning outcomes, each winning outcome is multiplied by the selected multiplier.

WILD4 occurs during the 138 credit bet option only and may result in the processor 204 awarding a composite game in the form of composite Feature ABC. That is, a feature having game play characteristics of each of the feature games of Features A, B and C. When selected by processor 204, WILD4 substitutes for all symbols except WILD1, WILD2, and WILD3. That is, from the game mechanics of three feature games (Feature A, Feature B, and Feature C), six feature games may be offered (Feature A, Feature B, Feature C, Feature AB, Feature AC, Feature BC, and Feature ABC). In some embodiments, WILD4 may be a composite feature symbol that visibly represents the combination of feature games from which the game characteristics are combined. For example, WILD4 may include the character, along with the PURPLE PIG and GREEN PIG, indicative of the composite game corresponding to WILD4 including game characteristics from Feature A, Feature B, and Feature C.

WILD5 occurs during all bet options and substitutes for all symbols except WILD1, WILD2, WILD3, WILD4, WILD6, and SCATTER. WILD5 has the same appearance as WI LD1 but has a different color background and doesn't trigger further game play.

In this example, there are also two different scatter symbols: SCAT1 and SCAT2. SCAT1 appears during the base game at can result in an option to win a Wheel Feature as described in further detail below. SCAT2 appears in at the feature games except Feature ABC.

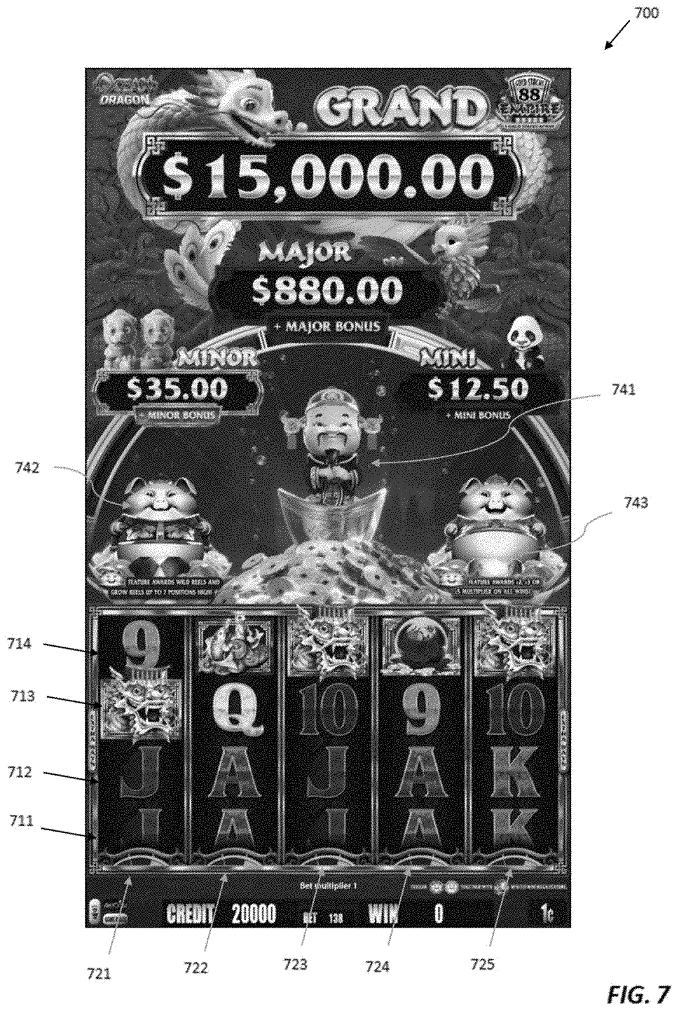

At step 515, the processor 204 selects symbols for a spinning reel game and controls the display 240 to display the selected symbols. FIG. 7 shows an example screen display 700 of a base game where symbols are selected from five reel strips for display in five columns of symbol positions 721-725 with four symbols being selected from each reel strip such that there are also four rows 711-614 of symbol positions.

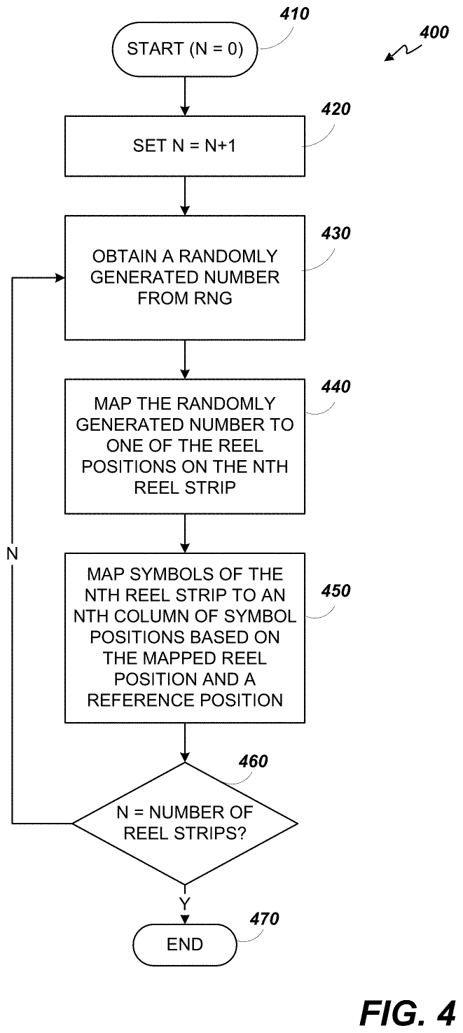

FIG. 4 is a flow chart of an example method 400 carried out by the processor 204 to select symbols from reel strips at step 510. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor 204 obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to an nth column of symbol display positions based on the mapped reel position and a reference position. In an example, the reference position is the top position of the symbol positions of each column of symbol positions. That is, the symbol positions in top row 714. In this example, the selected reel position (and hence the symbol at this position) is mapped to the top symbol position of the column. Referring to the example reel strips of FIG. 3, if the value returned by the RNG 212 is mapped to reel position 313 when four symbols are being selected from each reel as shown in FIG. 7, then for the first reel strip 341, “10” is mapped to a first, top symbol position, “WILD1” symbol is mapped to a second symbol position beneath the top symbol position, “K” symbol is mapped to a third symbol position, and “PIC1” symbol is mapped to a fourth, top symbol position.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. In other example, different numbers of symbols may be mapped to different numbers of symbol positions.

After the symbols of all reel strips have been mapped to symbol position, the processor 204 controls display 240 to display them at the symbol positions.

After the symbols are selected, at step 515, the processor 204 evaluates the selected symbols at step 520 for one or more winning combinations based on a pay table stored in memory. In this example, processor 204 applies a “ways to win” type evaluation by processing the selected symbols to identify instances of the same symbol appearing in consecutive columns from left to right. Upon there being one or more winning combinations, the processor 204 makes an award for each winning combination based on any selected bet multiplier, for example, by adding credit amounts defined by the pay table to a meter such as a win or credit meter in memory 204.

Processor 204 then conducts a feature determination comprising number of processes that determine whether an individual feature game or a composite feature game should (or should not) be initiated based on the selected symbols. As described above the reel strips may be configured with a number of different wild symbols which may trigger a feature game and also include a scatter symbol which can trigger a wheel feature when included in a triggering combination with a plurality of wild symbols. In this respect, at step 525, the processor 204 determines whether the selected symbols include a scatter win. In this example, at least one scatter symbol in combination with two or more wild symbols at any of the symbol positions.

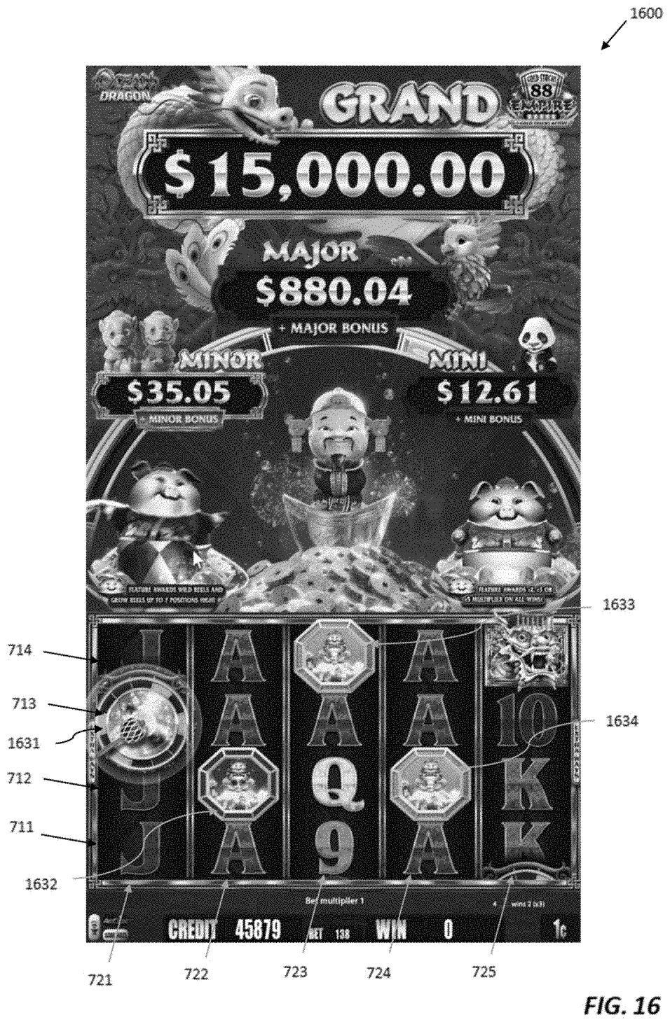

FIG. 16 is an example screen display 1600 of a scatter (SCAT1) win; that is, a triggering combination of eligible wild symbols and a scatter symbol. In FIG. 16, the player has selected the 138 credit bet option 803. (In an example, the player must select either the 118 credit or 138 credit bet option to be eligible.) In this example, a scatter symbol 1631 has been selected in the first column 721 of symbols positions (also known as the first reel), a WILD2 symbol 1632 (PURPLE PIG) has been selected in the second column (second reel), and WILD3 symbols 1633,1634 (GREEN PIG) have been selected in the third and fourth columns (third and fourth reels).

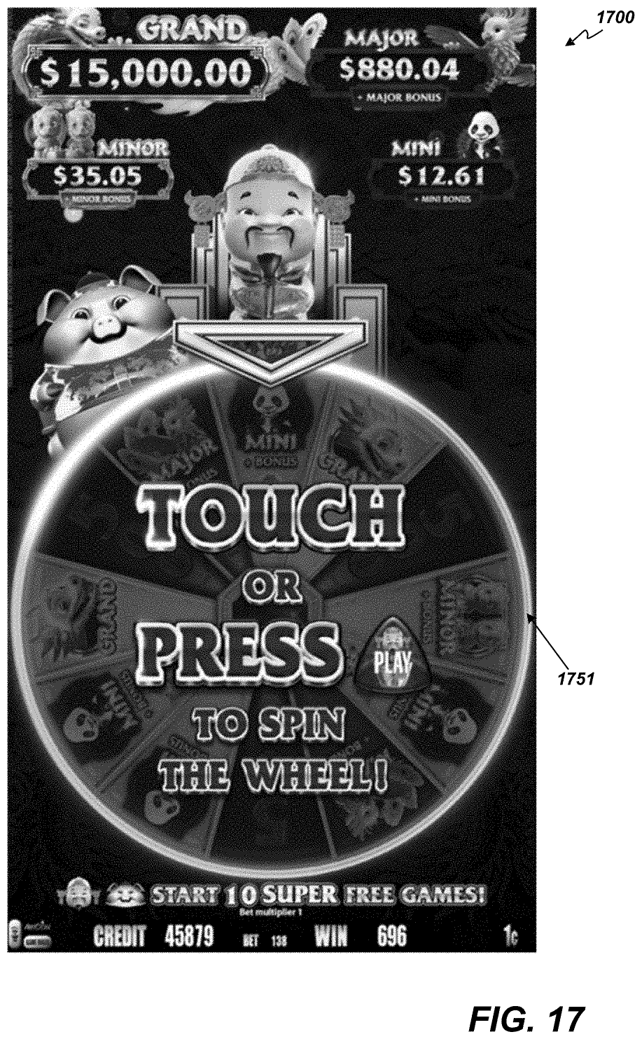

Accordingly at step 525, the processor 204 makes a positive determination and controls the display 240 to display screen display 1700 as shown in FIG. 17 which incorporates the prize award message 1751 “Touch or Press [Play Button] to Spin the Wheel!”. Processor 204 then proceeds to step 530 of selecting wheel prizes based on the wild symbols included in the triggering combination. Table 3 sets out possible features that can be triggered based on selected wild symbols without a SCAT1 win (center column) and with a SCAT1 win. In this Table, the letter corresponds to the features described above. That is the letter “A” corresponds to a Feature A. Combinations of letters (e.g. “BC”) refer to composite or “Super” Features made up of game play characteristics of multiple feature games (e.g. Feature B and Feature C). That is, Super Feature BC incorporates the game mechanics of both Feature B and Feature C.

In this example, not all wilds can result in an eligible scatter win in order to control the return to player from this part of the game and also to provide different possible outcomes relative to the wild trigger mechanic described in further detail below. Accordingly in this example, the determination performed by processor 204 at step 525 is whether the win is an eligible SCAT1 (scatter win) comprising the WILD2 and WILD3 wild symbols. In other examples, all combinations of wild symbols may result in a wheel feature being initiated. In some examples, weighting tables are configured so that only certain features can be triggered. In other examples, different features may be eligible to be triggered.

TABLE 3

| | | Possible Features |
|---|---|---|
| | Possible Features that | that can Triggered |
| | can Triggered when | when there is a |
| WILDs Selected | there is no SCAT1 win | SCAT1 win |
| WILD1 | A | — |
| WILD2 | B | A or AB |
| WILD3 | C | A or AC |
| WILD1 and WILD2 | A, B, or AB | — |
| WILD1 and WILD3 | A, C, or AC | — |
| WILD2 and WILD3 | B, C, or BC | A, AB, AC, or ABC |
| WILD1, WILD2, and | A, B, C, AB, AC, BC, or | — |
| WILD3 | ABC | |
| WILD4 | ABC | — |

At step 530, processor 204 retrieves a weight table from memory 208 corresponding to the wild symbols. In this example, as both WILD2 and WILD 3 have been selected, processor 204 calls a weight table that defines relative probabilities of selecting between prize wheels comprising Feature A, Feature AB, Feature AC and Feature ABC. Processor 204 then obtains a value from RNG 212 to select a prize wheel. In an example, based on the relative probabilities, the processor 204 assigns ranges of values returnable by RNG 212 to the respective outcomes. In example, a possible outcome is that no wheel is triggered or that the prize wheel doesn't include feature prizes.

In an example, processor 204 uses a further weight table to determine a number of free games to be awarded if the feature is awarded.

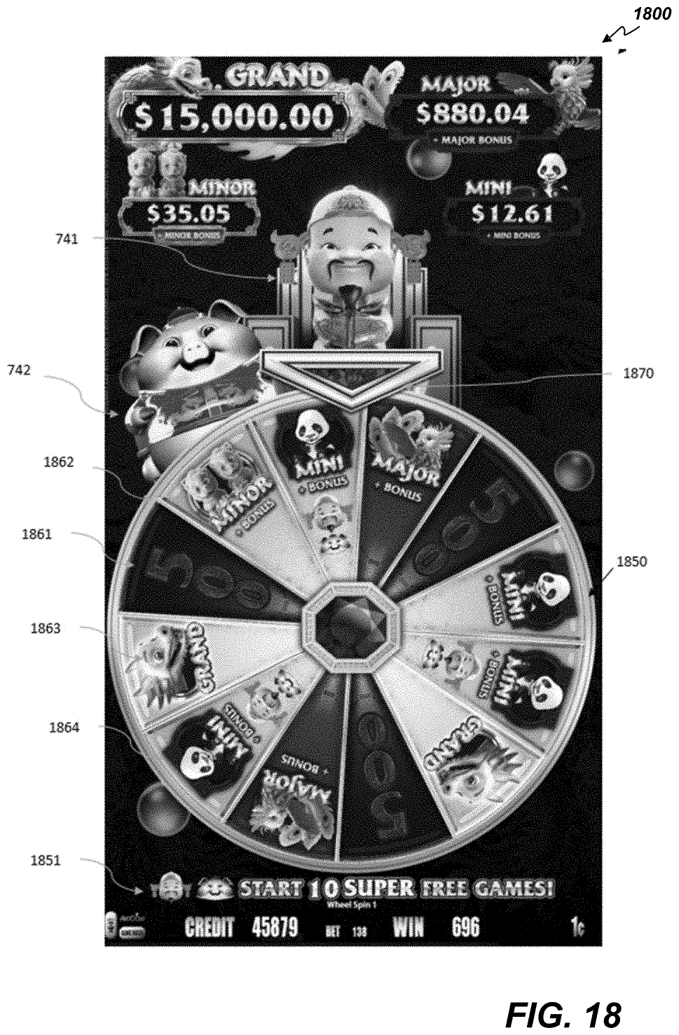

Screen display 1800 of FIG. 18 illustrates an example result of this process. In respect, the first feature icon 741 (associated with Feature A) and the second feature icon 742 (associated with Feature B) are display above wheel 1850 indicate that possible prize from this prize wheel included the award of Feature AB. Accordingly, the combination of feature icons presented is indicative of composite games made available. Prize wheel 1850 has twelve segments with a mixture of prizes. In this example, a mixture of credit prizes (e.g. segment 1861), bonus plus jackpot prizes (e.g. segment 1862), jackpot prizes (e.g. segment 1863), and feature prizes in combination with bonus and jackpot prizes (e.g. segment 1864). Message 1851 indicates that segments with “[First and second feature icon] Start 10 Super Free Games!”). In other examples, there may be more or fewer segments. In other examples, there may be different prizes. Also, in some examples, some segments may not have a prize.

At step 535, the processor 204 causes the wheel to spin and awards the selected prize. In an example, there is a weight table stored in memory 208 for each wheel that defines the relative probability of each segment being selected and processor 204 uses the relative probabilities and a value returned from RNG 212 to select a segment. Processor 204 then animates spinning of the wheel 1850 such that the selected segment stops in registration with award indicating arrow 1870. The processor 204 then awards any credit prizes by adding them to win meter or credit meter in memory 208 and any feature by setting the feature as awarded. At step 540, processor 204 determines whether a feature is awarded, and if no feature is awarded, the game instance ends at step 580.

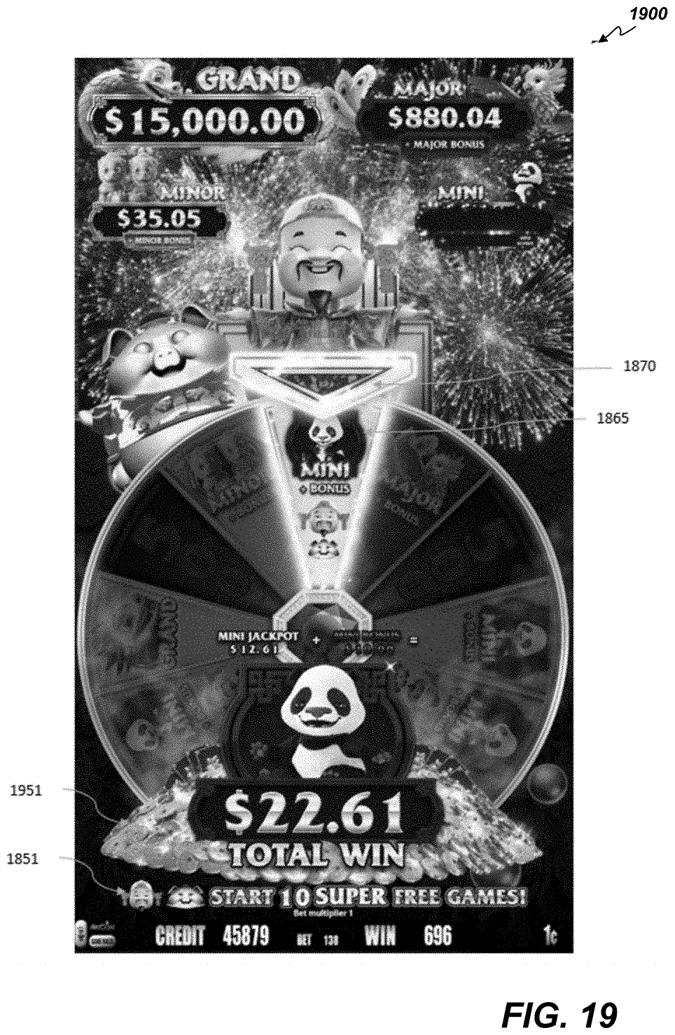

FIG. 19 is an example screen display 1900 where the selected prize includes the award of a feature game, in this example, Composite or “Super” Feature AB. In this example, segment 1865 has been stopped by processor 204 in registration with arrow 1870. Both segment 1865 and arrow 1870 are animated to highlight the selection while the remaining segments are greyed out and displayed behind a prize award message that indicates that the award includes is “Mini Jackpot $12.61+Mini Bonus $10. $22.61 Total Win”. Segment 1865 also includes Feature A and Feature B icons 741,742 such that it is communicated that the award also includes 110 free super games as indicated by message 1851.

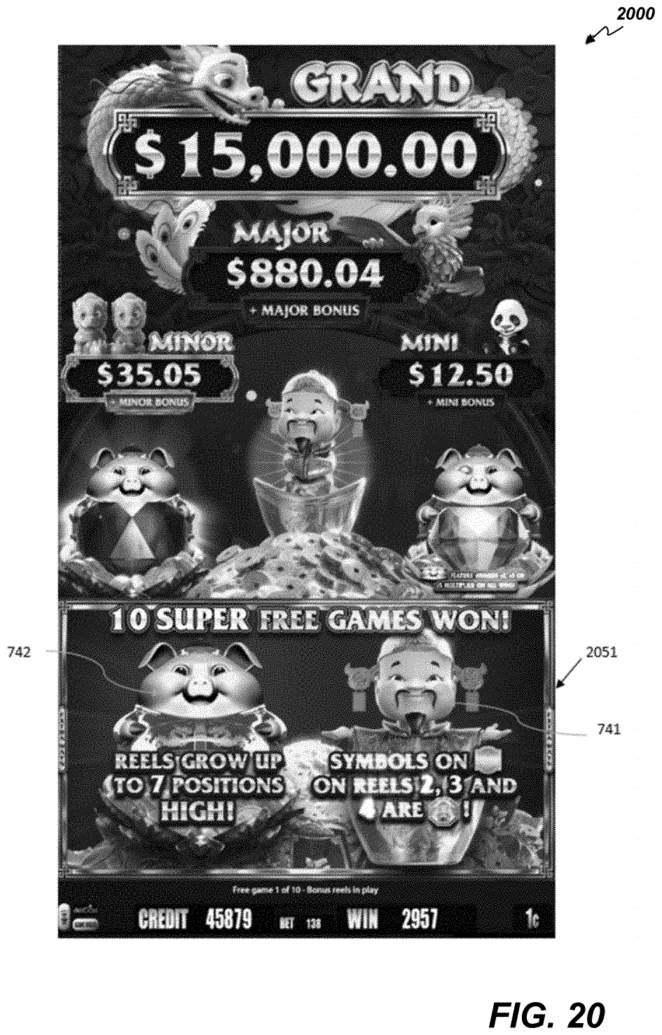

Processor 204 then controls display 240 to transition to a further award screen 2000 of FIG. 20 that has a feature award message with text indicating “10 Super Free Games Won!”, text “Reels Grow Up to 7 Positions HIGH!” overlaying Feature B icon 742, and text “Symbols on [Stack] on Reels 2, 3, and 4, are [WILD5]!” overlaying Feature A icon 741. Advantageously, the juxtaposition of the messages and the feature icons indicate the relationship between game play characteristics of the composite feature and the individual feature games. That is, each message is presented in association with the feature icon for the feature game to which it belongs.

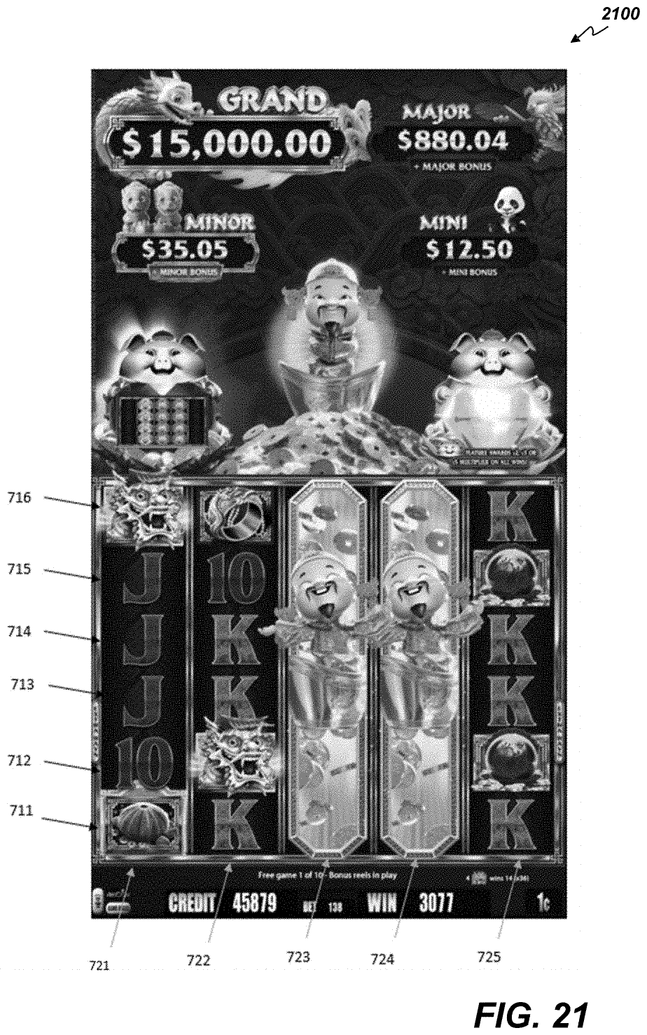

At step 550, processor 204 conducts the awarded feature game as described in further detail below. Example screen display 2100 of FIG. 21 shows a game instance generated during the feature game corresponding to FIG. 20 where there are six rows 711-716 of symbol positions in each column 721-725. That is, each reel has grown to six symbol positions high.

When at step 525, processor 204 makes a negative determination, processor 204 proceeds to step 555 and determines whether there are any wild symbols in the selected symbols. If the processor 204 makes a negative determination at step 555, the game instances ends 580. In the case where processor 204 makes a positive determination at step 555, processor 204 proceeds to step 560 and sets the probability of triggering the feature game. In this respect, as indicated above in the second column of Table 3, the triggerable features depend on the identity of the selected wild symbols.

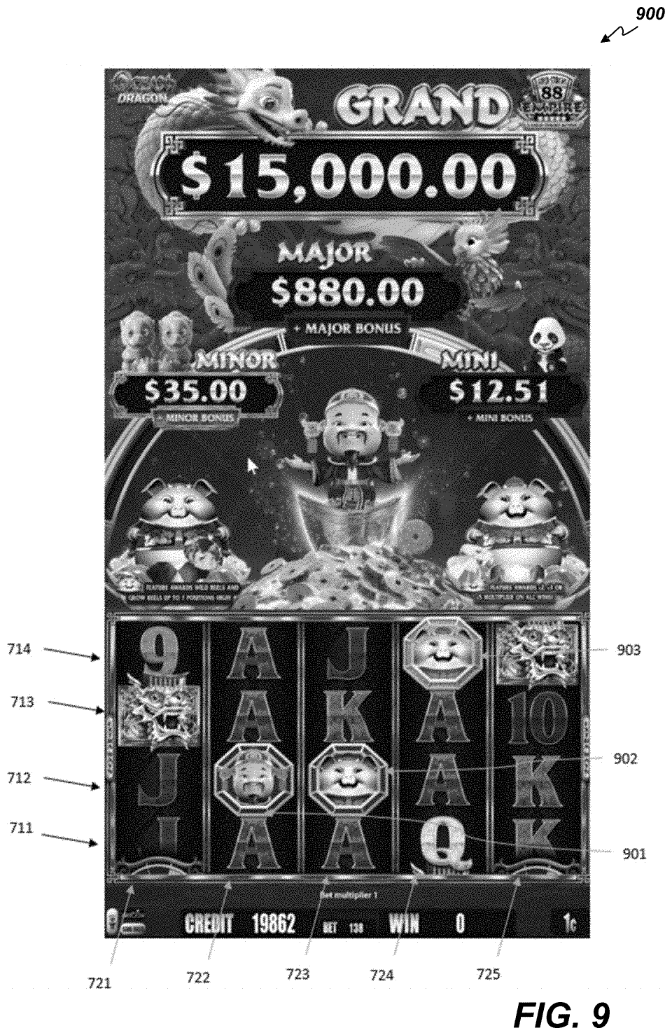

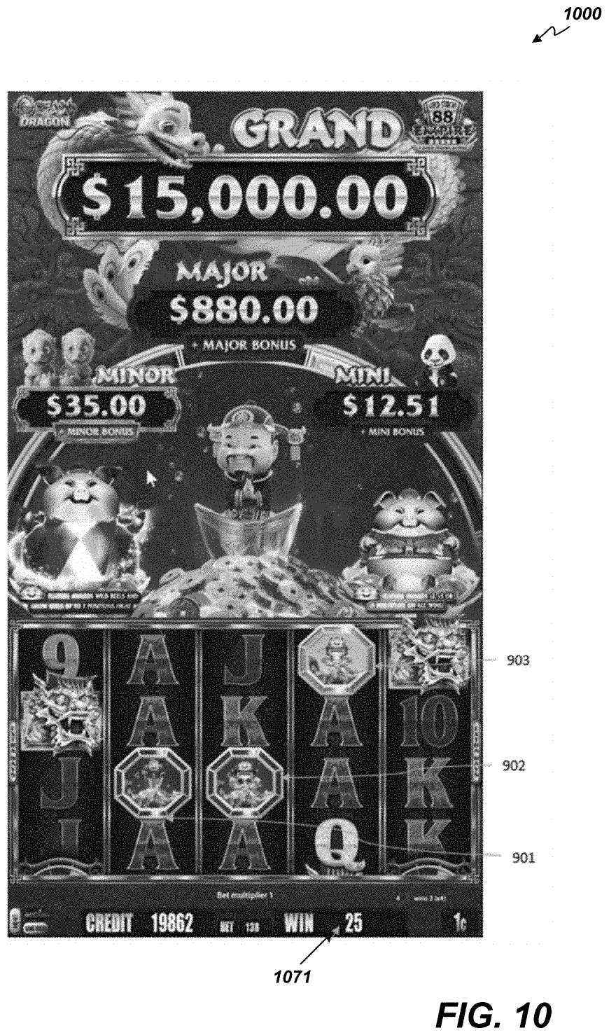

Referring to FIG. 9, there is shown an example screen display 900 where the selected symbols at step 515 include WILD1 901, WILD2 902 and WILD 3. Accordingly, in this example, processor 204 will make a positive determination at step 555 a proceed to conduct a feature determination in steps 560-570 in order to determine whether to initiate a feature game. (Note also that as shown in the example screen display of FIG. 10, processor 204 has evaluated the selected symbols at step 520 and made an award of 25 credits to the win meter 1071.)

Accordingly, at step 560, the processor 208 retrieves a weight table corresponding to the identities of the selected wild symbols. Each weight table defines a relative probability of each triggerable feature being selected. In the case of FIG. 9, where the selected symbols include WILD1, WILD2 and WILD3, an example weight table defines relative probabilities of triggering no feature, Feature A, Feature B, Feature C, Feature AB, Feature AC, Feature BC and Feature ABC. Where the selected wild symbols include WILD4, processor 204 retrieves a separate weight table from memory that defines the probability of defining Feature ABC.

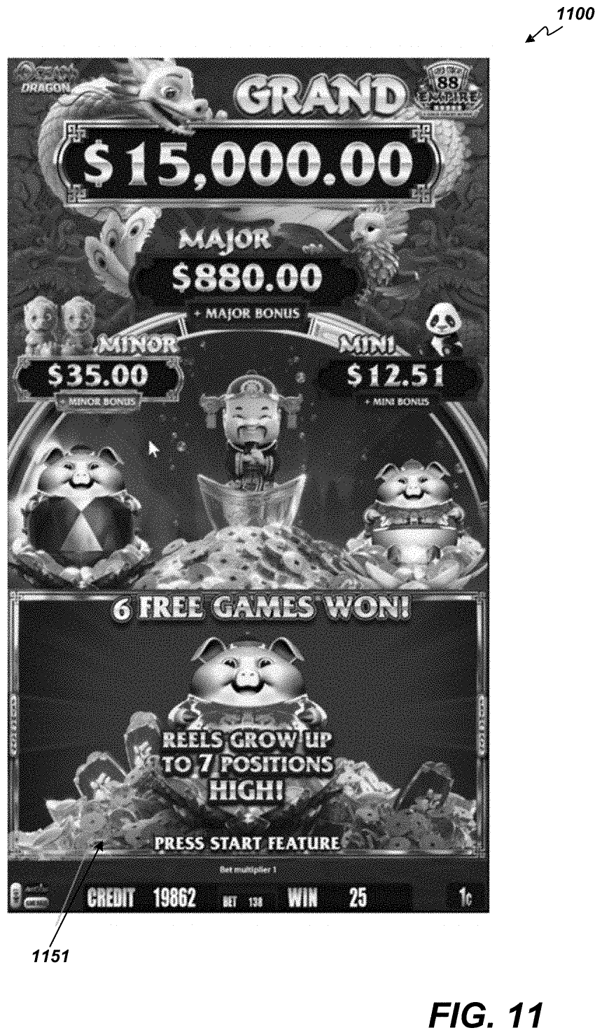

At step 565, processor 204 conducts a random determination using the retrieved weight table and a value generated by random number generator 212. If WILD 4 is selected in conjunction with one or more of WILD1, WILD2 and WILD3, separate random determinations are conducted at step 565. At step 570, processor determines whether the feature(s) have been awarded and if so proceeds to step 550 and conducts the feature game. In the rare case that more than one feature is awarded, these are conducted by processor 204 consecutively. FIG. 11 shows an example screen display 1100, where the result of conducting the random determination at step 565 is that the processor 204 awards Feature B at step 570 and controls the display to display and award message “6 Free Games Won! Reels Grow up to 7 Positions High!”.

In some examples, the number of free games for each feature is fixed. In other examples, a separate determination is conducted to determine how many free games are played following award of the feature. For example, 6, 10 or 20 free games.

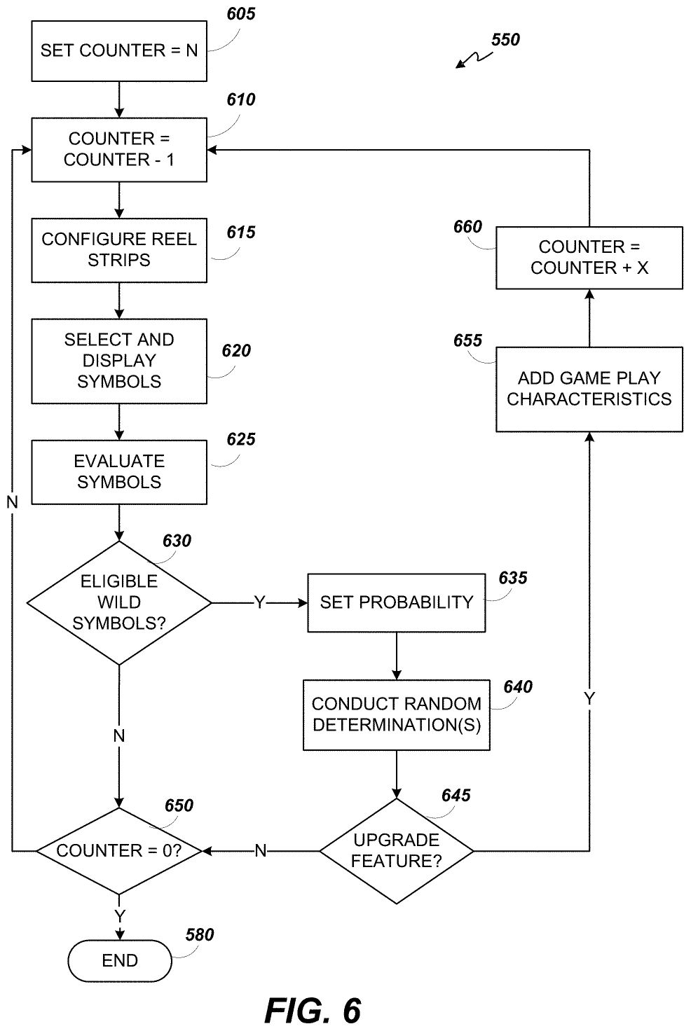

Referring to FIG. 6, there is a shown an example embodiment of conducting the awarded feature. At step 605, the processor 204 sets a counter N based on the number of awarded free games (e.g. to reflect that the processor 204 will conduct 6, 10 or 20 game instances). At step 610, processor 204 decrements the counter by one to reflect initiation of a game instance.

At step 615, the processor configures the reel strips for use in current game instance. In this example, the makeup of the reel strips, and in particular the wild symbols, depends on the triggered feature. In some example processor 204 configures the wild symbols by conducting independent random evaluations based on a weight table in a manner similar to that described above. In other examples, the wild symbol is set. The reel strips of the feature games may be different to the base game and one another.

In an example, the processor 204 configures wild symbols as set out in Table 4 below.

TABLE 4

| Feature | Configuration of wilds |
|---|---|
| A | Random selection between WILD2 and WILD3 |
| B | Random selection between WILD1 and WILD3 |
| C | Random selection between WILD1 and WILD2 |
| AB | Set to WILD3 |
| AC | Set to WILD2 |
| BC | Set to WILD1 |
| ABC | Set to WILD5 |

Accordingly in the case of an award of Feature B as described in connection with FIG. 11, at step 615 processor 204 makes a random determination as to whether each wild symbol will be WILD1 or WILD3.

At step 620, processor 204 selects symbol from the configured reel strips using the process describe above in relation to FIG. 4. Processor 204 also implements any feature specific game mechanics.

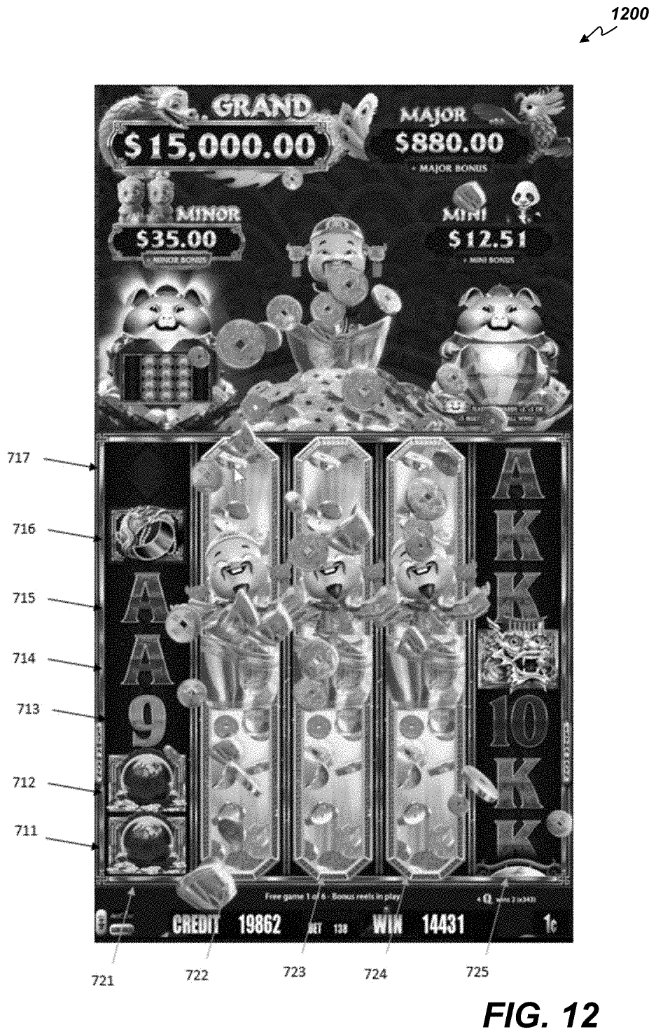

In this respect, FIG. 12 is an example screen display 1200 during Feature B where the reels have grown to seven symbol positions high such that there are seven rows 711-717 and second, third and fourth reels have become wild reels. In this example, processor 204 maps additional symbols to the added rows based on the selected reel strip position and the reference positions. As depicted, the feature icon for feature B 742 is modified in display to present contextual information regarding the game mechanic during a particular instance. As shown, feature icon B depicts a mechanic by which a user can win.

At step 625, the processor 204 evaluates the selected symbols for winning combinations based on the pay table in memory 208 and makes any awards, e.g. by adding credits to the win or credit meter in memory.

In some embodiments, when WILD1, WILD2 and/or WILD3 are selected for active symbol positions during a feature, there is a weighted chance that the processor 204 will trigger a feature upgrade and award at least one addition game instance (e.g. 3 additional free games) so that the upgraded feature is conducted in any remaining game instances on the counter in memory and the at least one additional game instanced. Table 5 sets out possible feature upgrades based on the current feature state (the current feature being conducted) and the selected wild symbols.

TABLE 5

| | | Possible Feature |
|---|---|---|
| Feature State | Wilds Selected | Upgrade |
| A | WILD2 | AB |
| A | WILD3 | AC |
| A | WILD2 and WILD3 | AB, AC, or ABC |
| B | WILD1 | AB |
| B | WILD3 | BC |
| B | WILD1 and WILD3 | AB, BC, or ABC |
| C | WILD1 | AC |
| C | WILD2 | BC |
| C | WILD1 and WILD2 | AC, BC, or ABC |
| AB | WILD3 | ABC |
| AC | WILD2 | ABC |
| BC | WILD1 | ABC |

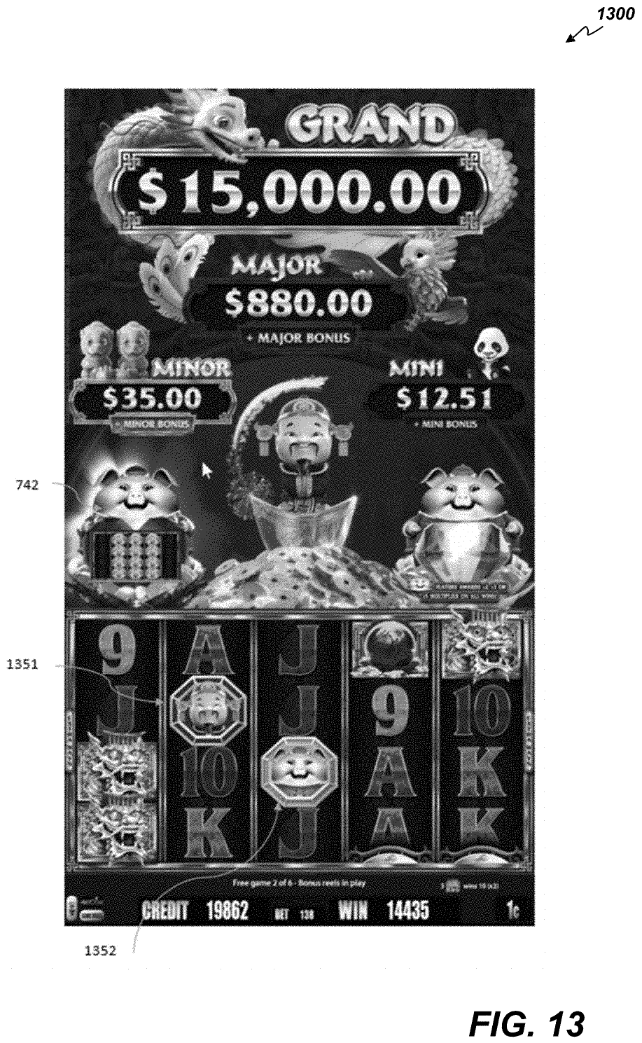

In this respect, FIG. 13 shows an example screen display 1300 during feature B as indicated in part by the state of second feature icon 742. In this example screen display, the symbols selected by the processor 204 include a WILD1 1351 and a WILD3 1352. Accordingly, in this example, at step 635 processor 204 sets probabilities by accessing a weight table in memory that defines relative probabilities of awarding no upgrade, an upgrade to feature AB, an upgrade to feature AC, and an upgrade to feature ABC. Put another way, these relative probabilities define the chance of the processor adding game play characteristic A, game play characteristic C or both game play characteristics A and C to the current feature when an upgrade condition is met.

At step 640, the processor 204 conducts a random determination 640 using the relevant weight table and a value returned by RNG 212. At step 645, the processor 204 determines whether this determination results in an upgrade of the feature and if not, determines at step 650 whether the counter has reached zero (that is, whether all the free games have been conducted). If the counter has reached zero, the feature is finished and the game ends 580. If the counter is non-zero, processor 204 reverts to step 610 and conducts the next game instance.

Where processor 204 makes a positive determination at step 645, processor outputs an award message 1451 such as that shown in the example screen display 1400 which corresponds to an example where the result of the random determination is an upgrade to Feature ABC. In this respect, in this example as well as the message 1451 stating “Upgrade Won!” and “+3 Additional Free Games”, message 1451 indicates the game play characteristics that will apply in the next game, in this case with “Symbols on [Stack] on Reels 2, 3, and 4, are [WILD5]!” overlaying Feature A icon 741, “Reels Grow Up to 7 Positions HIGH!” overlaying Feature B icon 742, and “Win Multipliers ×2, ×3 or ×5!” overlaying Feature C icon 743. In other examples, the upgrade message 1451 indicates what additional game play characteristics(s) are added.

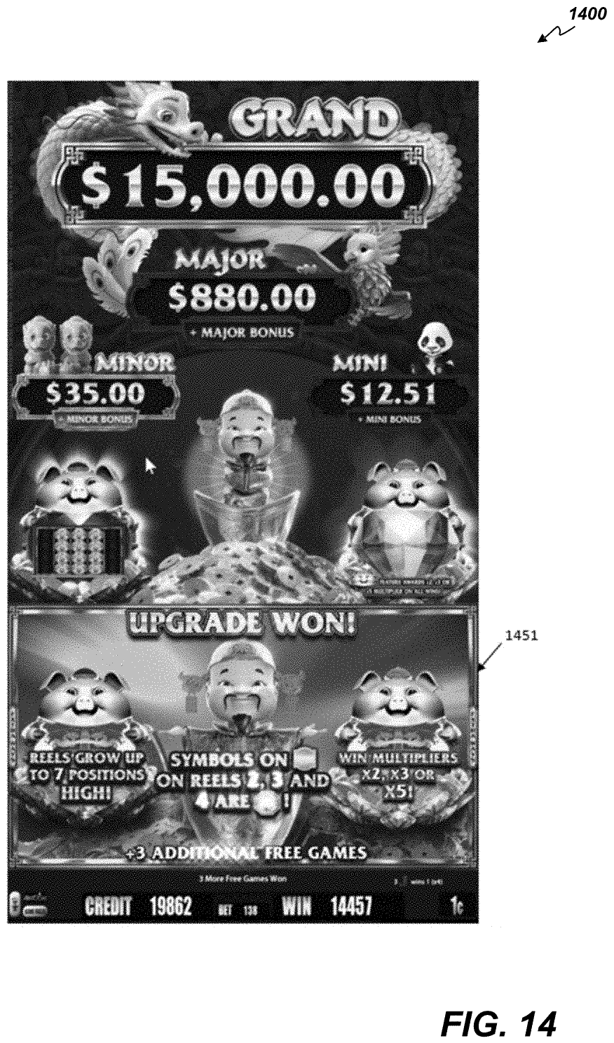

At step 655, processor adds the additional game play characteristics (for example, by setting the next feature to be conducted as feature ABC) and at step 660 processor increments the counter by the number of added game instances “X” (in this example 3) before proceeding to conduct the next game instance starting at step 610. In this respect, it will be appreciated that upgrading the feature will result in the reel strips being configured differently at step 615. In the case of the upgrade awarded in FIG. 14, this will result in all wild symbols being WILD5 in subsequent game play.

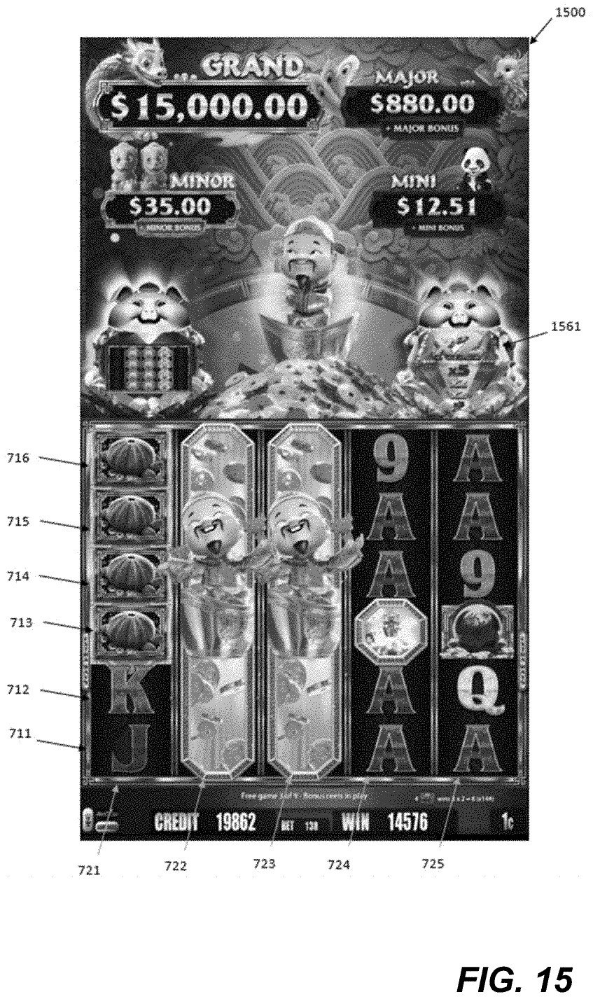

FIG. 15 shows an example, of symbols selected by processor 204 at step 620 during the upgraded feature. In this example, the reels have grown to six rows high 711-716, second and third reels 722,723 have turned wild and a ×2 multiplier 1561 has been awarded.

As indicated above, in this example, as shown in Table 5, no further upgrades can be awarded accordingly, at step 630 processor will make a negative determination that there are wild symbols that are eligible for an upgrade and proceed to step 650 of determining whether the counter has reached zero so that the processor 204 will revert to step 610 until all game instances have been conducted at which stage processor 204 will end the current play of the game at step 580 and await a further wager. It will be apparent that the disclosed upgrade process as well as advantageously allowing a feature to be upgraded and a player to have at least one additional game instance with the upgraded feature, also advantageously allows the processor 204 to upgrade the process more than once in the case where there are at least three features.

In other example, more features can be incorporated (e.g. 4 or 5 features) so that there are a more combinations of composite features, however, three features is advantageous in that it allows multiple upgrades without the combined game play mechanic becoming overly complex. Three features/game play mechanics are also preferred over embodiments with two features/game play mechanics because upgrades can result in different outcomes for at least some of the game states.

It will be appreciated that in other examples, alternative mechanics can be used to determine whether an upgrade condition is met in respect of a feature game, for example, alternative symbols that trigger a feature determination.

While FIG. 5 shows the process of evaluating for a scatter win being conducted prior to evaluating the wild symbol trigger, these processes can be conducted in the reverse order. Both processes can also be conducted by processor 204 prior to displaying the selected symbols on display 240.

### Example Embodiments

In an example embodiment, there is provided a gaming device comprising:
a display;
a random number generator;
a processor; and
a memory storing instructions which, when executed by the processor, cause the processor to:
conduct a spinning reel base game from which a plurality of feature games can be triggered, each of the plurality of feature games comprising different game play characteristics and each associated with a respective wild symbol of a plurality of different wild symbols, wherein each wild symbol substitutes for at least some other symbols in evaluation of the symbols selected from reel strips in the spinning reel base game for winning combinations of symbols;
in response to the symbols selected from the reel strips including a triggering combination formed from at least two different wild symbols associated with different feature games of the plurality of feature games, conduct a feature determination using the random number generator, wherein possible outcomes of the feature determination include (i) awarding an individual feature game corresponding to a respective one of the at least two different wild symbols and (ii) awarding a composite feature game comprising game play characteristics of two or more feature games corresponding to wild symbols of the triggering combination; and
conduct any triggered feature game.

In an example embodiment, a possible outcome of the feature determination is that no feature is awarded.

In another example embodiment, there is provided a method of operating a gaming device comprising a display, a random number generator, the method comprising:
conducting a spinning reel base game from which a plurality of feature games can be triggered, each of the plurality of feature games comprising different game play characteristics and each associated with a respective wild symbol of a plurality of different wild symbols, wherein each wild symbol substitutes for at least some other symbols in evaluation of the symbols selected from reel strips in the spinning reel base game for winning combinations of symbols;
in response to the symbols selected from the reel strips including a triggering combination formed from at least two different wild symbols associated with different feature games of the plurality of feature games, conducting a feature determination using the random number generator, wherein possible outcomes of the feature determination include (i) awarding an individual feature game corresponding to a respective one of the at least two different wild symbols and (ii) awarding a composite feature game comprising game play characteristics of two or more feature games corresponding to wild symbols of the triggering combination; and conducting any triggered feature game.

In an example embodiment, there is provided a system comprising:
at least one display;
a random number generator;
one or more processors; and
memory storing instructions which, when executed by the one or more processors, cause the one or more processors to:
conduct a spinning reel base game from which a plurality of feature games can be triggered, each of the plurality of feature games comprising different game play characteristics and each associated with a respective wild symbol of a plurality of different wild symbols, wherein each wild symbol substitutes for at least some other symbols in evaluation of the symbols selected from reel strips in the spinning reel base game for winning combinations of symbols;
in response to the symbols selected from the reel strips including a triggering combination formed from at least two different wild symbols associated with different feature games of the plurality of feature games, conduct a feature determination using the random number generator, wherein possible outcomes of the feature determination include (i) awarding an individual feature game corresponding to a respective one of the at least two different wild symbols and (ii) awarding a composite feature game comprising game play characteristics of two or more feature games corresponding to wild symbols of the triggering combination; and
conduct any triggered feature game.

In another example embodiment, there is provided a gaming device comprising:
a display;
a random number generator;
a processor; and
a memory storing instructions which, when executed by the processor, cause the processor to:
conduct a spinning reel base game from which a plurality of feature games can be triggered, each of the plurality of feature games comprising different game play characteristics and each associated with a respective trigger symbol of a plurality of different trigger symbols
in response to the symbols selected from the reel strips including a triggering combination formed from a designated symbol and one or more trigger symbols associated with one or more of the plurality of feature games, conduct a feature determination using the random number generator, wherein possible outcomes of the feature determination include (i) awarding an individual feature game and (ii) awarding a composite feature game comprising a game play characteristic of the one or more of the plurality of feature games and at least one additional game play characteristic.

In an embodiment, the feature determination comprises controlling the display to display a wheel comprising a plurality of segments, at least one of the segments corresponding to a feature game, and the instructions cause the processor to select a segment of the wheel, and award the feature game upon the selected segment corresponding to the feature game.

In another example embodiment, there is provided a method of operating a gaming device comprising a display, a random number generator, the method comprising:
conducting a spinning reel base game from which a plurality of feature games can be triggered, each of the plurality of feature games comprising different game play characteristics and each associated with a respective trigger symbol of a plurality of different trigger symbols
in response to the symbols selected from the reel strips including a triggering combination formed from a designated symbol and one or more trigger symbols associated with one or more of the plurality of feature games, conducting a feature determination using the random number generator, wherein possible outcomes of the feature determination include (i) awarding an individual feature game and (ii) awarding a composite feature game comprising a game play characteristic of the one or more of the plurality of feature games and at least one additional game play characteristic.

In an example embodiment, there is provided a system comprising:
at least one display;
a random number generator;
one or more processors; and
memory storing instructions which, when executed by the one or more processors, cause the one or more processors to:
conduct a spinning reel base game from which a plurality of feature games can be triggered, each of the plurality of feature games comprising different game play characteristics and each associated with a respective trigger symbol of a plurality of different trigger symbols
in response to the symbols selected from the reel strips including a triggering combination formed from a designated symbol and one or more trigger symbols associated with one or more of the plurality of feature games, conduct a feature determination using the random number generator, wherein possible outcomes of the feature determination include (i) awarding an individual feature game and (ii) awarding a composite feature game comprising a game play characteristic of the one or more of the plurality of feature games and at least one additional game play characteristic.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A gaming device comprising:
a display;
a random number generator;
a processor; and
a memory storing instructions which, when executed by the processor, cause the processor to:
display a base game from which a plurality of feature games can be triggered and at least one composite feature game can be triggered, wherein the composite feature game comprises game play characteristics from a first feature game and a second feature game of the plurality of feature games, wherein the composite feature game comprises a combination of the different game play characteristics, and wherein the base game comprises a spinning reel game in which the processor selects symbols from reel strips using the random number generator;
initiate the composite feature game in response to a composite feature trigger condition being met, the composite game comprising a plurality of game instances having the combination of the different game play characteristics,
wherein the plurality of game instances are presented on the display with one or more feature game icons, wherein at least one of the one or more feature game icons is modified in presentation during the plurality of game instances in accordance with an associated game play characteristic for a particular instance.

2. The gaming device of claim 1, wherein the feature trigger condition is triggerable from base game.

3. The gaming device of claim 1, further comprising instructions to upgrade the composite feature game to a second composite feature game in accordance with an upgrade condition being satisfied.

4. The gaming device of claim 3, wherein the second composite feature game comprises game play characteristics from the first feature game, the second feature game, and a third feature game.

5. The gaming device of claim 3, further comprising instructions to make available the second composite feature game in accordance with a user selection of an increased wager.

6. The gaming device of claim 1, wherein the feature trigger condition for the composite game comprises a symbol representative of the combination of the first feature game and the second feature game.

7. The gaming device of claim 1, wherein the feature trigger condition comprises selection of a combination of symbols for the first feature game and the second feature game.

8. A method comprising:
displaying a base game from which a plurality of feature games can be triggered and at least one composite feature game can be triggered, wherein the composite feature game comprises game play characteristics from a first feature game and a second feature game of the plurality of feature games, wherein the composite feature game comprises a combination of the different game play characteristics, and wherein the base game comprises a spinning reel game in which a processor selects symbols from reel strips using a random number generator; and
initiating the composite feature game in response to a composite feature trigger condition being met, the composite game comprising a plurality of game instances having the combination of the different game play characteristics,
wherein the plurality of game instances are presented on a display with one or more feature game icons, wherein at least one of the one or more feature game icons is modified in presentation during the plurality of game instances in accordance with an associated game play characteristic for a particular instance.

9. The method of claim 8, wherein the feature trigger condition is triggerable from base game.

10. The method of claim 8, further comprising upgrading the composite feature game to a second composite feature game in accordance with an upgrade condition being satisfied.

11. The method of claim 10, wherein the second composite feature game comprises game play characteristics from the first feature game, the second feature game, and a third feature game.

12. The method of claim 10, further comprising making available the second composite feature game in accordance with a user selection of an increased wager.

13. The method of claim 8, wherein the feature trigger condition for the composite game comprises a symbol representative of the combination of the first feature game and the second feature game.

14. The method of claim 8, wherein the feature trigger condition comprises selection of a combination of symbols for the first feature game and the second feature game.

15. A non-transitory computer readable medium comprising computer readable code executable by one or more processors to:
display a base game from which a plurality of feature games can be triggered and at least one composite feature game can be triggered, wherein the composite feature game comprises game play characteristics from a first feature game and a second feature game of the plurality of feature games, wherein the composite feature game comprises a combination of the different game play characteristics, and wherein the base game comprises a spinning reel game in which the processor selects symbols from reel strips using the random number generator;
initiate the composite feature game in response to a composite feature trigger condition being met, the composite game comprising a plurality of game instances having the combination of the different game play characteristics,
wherein the plurality of game instances are presented on a display with one or more feature game icons, wherein at least one of the one or more feature game icons is modified in presentation during the plurality of game instances in accordance with an associated game play characteristic for a particular instance.

16. The non-transitory computer readable medium of claim 15, further comprising computer code to upgrade the composite feature game to a second composite feature game in accordance with an upgrade condition being satisfied.

17. The non-transitory computer readable medium of claim 16, wherein the second composite feature game comprises game play characteristics from the first feature game, the second feature game, and a third feature game.

18. The non-transitory computer readable medium of claim 16, further comprising computer readable code to make available the second composite feature game in accordance with a user selection of an increased wager.

19. The non-transitory computer readable medium of claim 15, wherein the feature trigger condition for the composite game comprises a symbol representative of the combination of the first feature game and the second feature game.

20. The non-transitory computer readable medium of claim 15, wherein the feature trigger condition comprises selection of a combination of symbols for the first feature game and the second feature game.
